(19) United States
(12) Patent Application Publication
(10) Pub. No.: US 2007/0106744 A1
(43) Pub. Date: May 10, 2007

(54) Method, apparatus and computer program product for determining a destination at which a group of devices can store data associated with the devices

(75) Inventors: Richard M. Bicheno, Havant Hampshire (GB); Kevin A. Braithwaite, Southampton Hampshire (GB); Marc S. Carter, Southampton (GB); Tim Dunn, Hampshire (GB)

Correspondence Address: BOND, SCHOENECK & KING, PLLC, ONE LINCOLN CENTER, SYRACUSE, NY, 13202-1355, US

(73) Assignee: International Business Machines Corporation, Armonk, NY (US)

(21) Appl. No.: 11/593,888

(22) Filed: Nov. 7, 2006

(30) Foreign Application Priority Data
Nov. 10, 2005 (GB) 0522941.4

(51) Int. Cl. G06F 15/167

(52) U.S. Cl. 709/213; 709/223

(57) ABSTRACT

There is disclosed a method apparatus and computer program for a master of a group of devices to determine a destination at which to store data associated with the devices in the group. Destination preference information is received from each device in the group. Such information is analysed to arrive at a preferred destination and then the device in the group are informed of this preferred destination.

### PRIORITY CLAIM

The present application claims priority to Great Britain Patent Application No. 0522941.4, filed Nov. 10, 2005, the entire disclosure of which is hereby incorporated by reference.

### FIELD OF THE INVENTION

The present invention relates to determining a destination at which a group of devices can store data associated with the devices.

### BACKGROUND OF THE INVENTION

Computing devices are becoming increasingly more powerful and portable. Added to this, connectivity is continually improving such that users may be connected to the Internet and to one another's devices almost wherever they are, be that on public transport, at a party, in the office or at home. PDAs, phones, even cameras now have the ability to access information over the Internet and to communicate with one another. Users are now able to share information with one another via a multitude of means, for example, instant messaging, email, an infrared link etc.

One example of information that a user might like to share with other users is photos from a digital camera.

The problem with, for example, a room full of people at a party taking pictures of one another on their own cameras is that each person will typically categorise and store photos in a potentially different way.

This year, online digital photo albums are the technology of the moment. According to the BBC at website news.bbc.co.uk/1/hi/technology/4183947.stm, they fall into two categories:

i) Photo Libraries that let one store albums where others can get them; and

ii) As above, but linked to online printing services so that anyone looking at the photos can select which ones they want printed and have the set delivered. One example of this type of service is provided by Photobox™.

Thus some people may upload their photos to an online photo library for access. However, others may simply email their photos to a few friends.

Therefore sharing information such as photos is currently a problem.

### SUMMARY OF THE INVENTION

Accordingly there is provided a method for a master of a group of devices to determine a destination at which to store data associated with the devices in the group, the method comprising: receiving destination preference information from each device in the group of devices; analysing the preference information received to arrive at a preferred destination; and informing the devices in the group of the preferred destination to be used to store data.

In a preferred embodiment, the device acting as master of the group has volunteered to be master. Of course, in another embodiment the device may have been designated as master. It is, however, better if the device volunteers because then it can take account of its own capabilities and the preferences of its user when deciding whether to volunteer its services.

Once the device has been appointed as master, it preferably requests that each group member send its destination preference information.

Such information can then be analysed by applying rules thereto in order to weight the importance of the preference information received from the group members.

In one embodiment a request for renegotiation of the preferred destination may be received. At this point, the master preferably requests new preference information from the group members and such preference information is then analysed to determine whether a new destination is appropriate—for example whether the other group members want a new destination.

According to another aspect, there is provided a method for an initiator device to initiate the process of determining a destination at which to store data associated with a plurality of devices, the method comprising:
asking each of the plurality of devices whether it wishes to join a group, the purpose of the group being to arrive at a common destination for storing data associated with the plurality of devices; and receiving acceptances to join the group from the plurality of devices.

Preferably information is provided to the devices as to the purpose of the group.

Preferably those acceptances are authenticated. This could be by means of a passcode or by checking to see whether the acceptances are from devices fulfilling group criteria. Those devices which have been authenticated are preferably registered as group members.

Preferably the initiator monitors for new devices to invite to join the group.

In a preferred embodiment, the initiator receives a message from at least one device in the group volunteering to be master of the group. In the preferred embodiment this is as a result of there being no master currently designated.

Preferably any messages received by which a device is volunteering to be master are analysed and a device is selected as master of the group. The group is then informed of the decision.

According to another aspect, there is provided a method for a subordinate device to participate as part of a group of devices in a determination as to a destination at which the group of devices should store data associated with respective devices in the group, the method comprising: receiving an invitation to join the group; accepting the invitation; receiving a request for preference information as to the destination at which the group of devices should store data; sending destination preference information to the master of the group; and receiving a destination at which to store the device's data.

Preferably, information received as part of the invitation is used to determine whether to accept the invitation. The information indicates the purpose of the group.

Once a destination has been designated by the master of the group, the data may be uploaded to that destination.

In one embodiment, the data is stored in a folder and the folder has the destination associated with it. In order to upload data, the data is retrieved from the folder and the destination associated with the folder is used in the upload process.

In another embodiment, the data has metadata associated therewith. The metadata is used in the uploading step.

In one embodiment, when notification of acceptance into the group is received, information pertaining to the group (group information) is stored).

In one embodiment, a request may be received from a newcomer for information pertaining to the group. This group information is sent to the newcomer.

The newcomer may, however, be first authenticated prior to sending out the group information.

In one embodiment, it is possible to request renegotiation of the preferred destination. If the request is accepted, preference information is sent to the master and an indication is received from the master as to whether a new destination has been selected by the master is received. Of course preference information may, in an alternative embodiment, be sent at the same time as the request.

According to another aspect, there is provided an apparatus for a master of a group of devices to determine a destination at which to store data associated with the devices in the group, the apparatus comprising: means for receiving destination preference information from each device in the group of devices; means for analysing the preference information received to arrive at a preferred destination; and means for informing the devices in the group of the preferred destination to be used to store data.

According to another aspect, there is provided an apparatus for an initiator device to initiate the process of determining a destination at which to store data associated with a plurality of devices, the apparatus comprising: means for asking each of the plurality of devices whether it wishes to join a group, the purpose of the group being to arrive at a common destination for storing data associated with the plurality of devices; and means for receiving acceptances to join the group from the plurality of devices.

According to another aspect, there is provided an apparatus for a subordinate device to participate as part of a group of devices in a determination as to a destination at which the group of devices should store data associated with respective devices in the group, the apparatus comprising: means for receiving an invitation to join the group; means for accepting the invitation; means for receiving a request for preference information as to the destination at which the group of devices should store data; means for sending destination preference information to the master of the group; and means for receiving a destination at which to store the device's data.

The invention may be implemented in computer software.

### BRIEF DESCRIPTION OF THE DRAWINGS

A preferred embodiment of the present invention will now be described, by way of example only, and with reference to the following drawings:

FIGS. 1 and 2 illustrate the processing of the present invention in accordance with a preferred embodiment of the present invention; and

FIG. 3 illustrates the componentry of the present invention in accordance with a preferred embodiment of the present invention.

### DETAILED DESCRIPTION

A mechanism is disclosed which enables automatic arbitration between computing devices in order to decide where to store information of interest to those devices. The preferred embodiment is described in terms of photographic devices sharing images; however the invention is applicable to any kind of data or device.

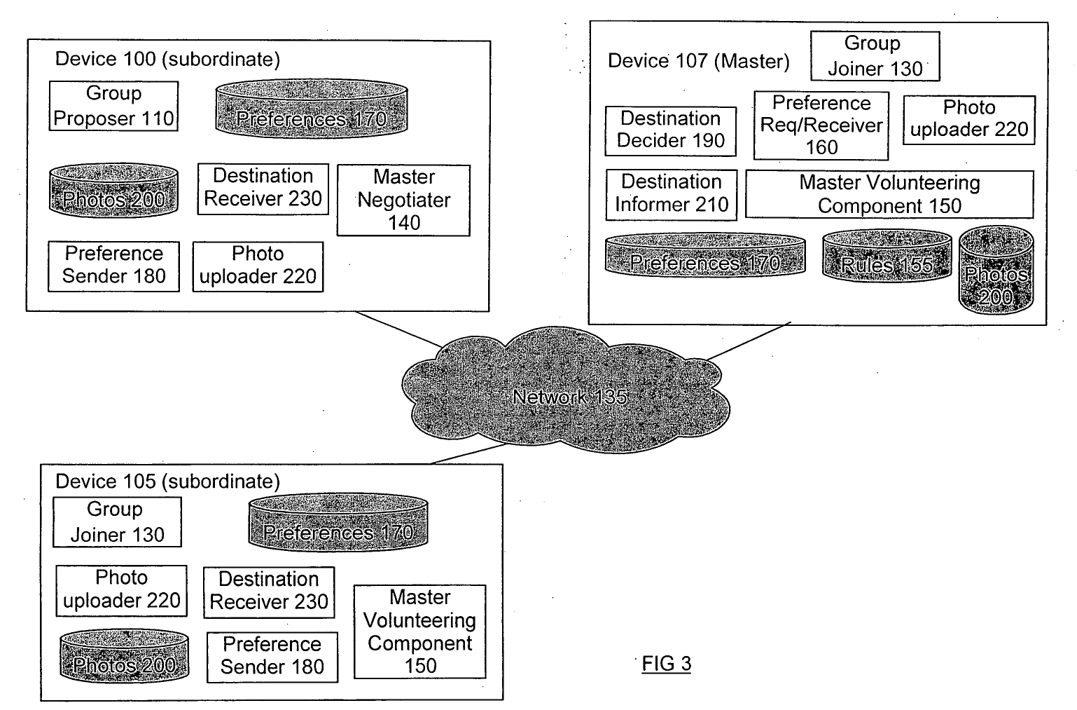

The processing of the preferred embodiment is described with reference to FIGS. I and 2, whilst the componentry is described using FIG. 3. The figures should be read in conjunction with one another.

A computing device 100 uses group proposer component 110 to broadcast its desire to form a collective group of devices willing to share information (step 10). The group proposer component 110 may simply broadcast an invitation to all devices within range or may use other criteria. For example, those devices connected to a particular network (e.g. a local wireless network 135); those devices pre-registered with a central service; those devices belonging to certain users; or those devices of a particular type.

Each device (e.g. 100) preferably has owner information associated therewith and this is used by the group proposer component to indicate who the invitation is from (e.g. Marc's camera). The user of the proposing device will preferably indicate to the group proposer component upon initiation the purpose of the group and this can then also be shared with the invitees (e.g. to swap photos from Marc's house warming party).

Each invited device (e.g. 105, 107) uses such information to make a decision, using group joiner component 115, whether to accept the received invitation and join the group. Such a decision may involve providing a user of the device with a popup dialogue box asking whether the user wishes to join the proposed group.

Those deciding to join the group, broadcast their acceptance (via group joiner component 115) to device 100 and this is received by group proposer component 110 and authenticated (e.g. to check that the device fulfils any group specific criteria such as a “device type”—again information such as device type is preferably already associated with each device and can be provided by the device when requesting to join the group) at step 20. Such devices are then registered with the group at step 30. Such devices may require a passcode which they can use to join or rejoin the group. This could, for example, be communicated verbally to the users of devices within range (e.g. at the party).

Note, the group proposer component 110 is preferably continually monitoring for new devices which satisfy its group criteria and thus a device may receive an invitation to join a group which is already up and running.

The absence of a master in the group initiates a master negotiation process at step 40. In other words, as each member joins the group they ask who the master is and are informed of this. If however a device is informed that there is as yet no master designated, then that device may volunteer for the role. In one embodiment (not illustrated) the initiator is automatically designated the master.

At step 50, the initiator's master negotiator component 140 receives notification of any group member's willingness to be designated master. Such a broadcast is preferably based on a determination by each group member as to whether they are capable of being designated master (master volunteering component 150). Such a decision may be based on user preferences or may be made using device capability information. By way of another example, device users may be specifically asked whether they want their device to be designated as master. For example, users may know that they are about to leave the party and consequently there is little point in volunteering for the role.

Device 100 then makes a decision (using master negotiator component 140) as to which group member is to be designated master. At its simplest, this may be the first device to broadcast its willingness. This is in line with the peer-to-peer approach taken by known networking protocols (e.g. in the Microsoft® Windows® networking environment—Microsoft and Windows are both registered trademarks of Microsoft Corporation in the United States and/or other countries.) However, it should be appreciated that just because a device is quickest to indicate a willingness, this does not mean that it is necessarily the most suitable device. Thus each volunteer (e.g. 105, 107) may also broadcast its capabilities to device 100. Device 100 may then take such information into account when selecting a master. The master negotiator component 140 preferably uses rules 155 to determine device suitability. For example, the following may be important: typical length of connectivity and processing power. Information regarding each member's ability to remain connected to a local network and the member's processing power may be used to decide whether or not to designate that member as master.

Thus a master is chosen at step 60 and the other members in the group are informed of the decision (step 70).

Once a master is chosen (e.g. device 107), it is up to the master to choose a destination for the members of the group to use to share their information (e.g. their photos). Thus the master requests, via Preference Requester/Receiver Component 260, that the group members broadcast their preferences 170 (step 80). Each group member has their preferences 170 stored locally and each subordinate's preferences sender component 180 uses these to inform the master of the destination that they would like to use. Note that the preferences may be categorised according to the type of information being shared. For example, if it is photos that are to be exchanged then destination (or destination type) x may be appropriate, whilst another destination may be selected for sound files etc..

The preferences information may simply be a list of locations in order of preference. A more complex set of preferences may indicate a type of destination based on factors such as acceptable cost of storage facility; whether a minimum upload speed is available; available image size; whether a photo delivery service is provided; whether the location has good access (e.g. is reliable); whether the location can provide good image quality etc..

Such preferences 170 are transmitted by each group member to the designated master 107 and are received at step 85 by the preference requester/receiver component 260. Note, the master may also have its own set of preferences 170.

Destination decider component 200 analyses the received preferences (and possibly its own) at step 90 to determine a destination for storing the group member's data (e.g. photos 150) Such an analysis preferably involves applying a set of rules 255 to the preferences. In this way, the importance of the various preference information received from each device is weighted. The following are examples of the way in which a decision may be arrived at:
Most voted-for destination
Most compatible destination (some devices may not be able to access all locations. For example, one device may have local area but not Internet access.)
Largest available storage space
Most local destination

Thus, as a result of the preferences analysis, destination decider component 200 arrives at a preferred destination. Destination informer component 210 then informs all group members of the destination that has been selected (step 95). By way of example, the destination could be the hard drive of a local PC, a teamroom of the sort provided by the IBM® Lotus Notes® product, an Internet website or an online commercial photo library. (IBM and Lotus Notes are registered trademarks of International Business Machines Corporation.)

Once a device has received notification of acceptance into a group, that device preferably stores group information comprising details of the group it belongs to, the type of data being shared by the group and the destination associated with the group. Note that multiple types of data may be being shared, each type with a different destination associated therewith. A single device may participate in multiple groups and those groups may share different types of data with potentially different destinations associated therewith. Such information may be stored, for example, in a format such as the Extended Markup Language (XML).

Now that each group member has been informed of a destination, it is up to the individuals concerned to upload their data (e.g. photos 150) to that destination via photo uploader component 120. Each user may have local preferences indicating when such uploading should take place. For example, one device may upload each photo immediately, whilst another device may prefer to upload the photos to a PC first and use the PC to deliver the photos to the selected destination (i.e. a delayed upload). The upload time may depend upon the type (e.g. urgency) of the data. Additionally such preferences may depend on Internet connectivity and processing power. Another factor may be local storage space—for example, a user may desire to upload photos immediately in order to make room for new photos.

A decision also has to be made as to which photos (or other data) are to be uploaded. This may be achieved by the device owner marking certain photos as shareable or storing the photos in a particular folder. The group information discussed above may then be used in the upload process. For example, when a group is created, one or more folders for associated data may be created at the same time. The user is then informed of the name of the one or more folders. When a destination is assigned this can be automatically associated with the folder as a folder property.

By way of another example, photos may be tagged with metadata. Thus a device (e.g. a camera or PC) may be used to associate a photo with one of its groups to annotate the photos with such metadata. For example, metadata could provide information such as destination, owner and group. When a user desires to annotate photos, they may be provided with various options (groups etc.) from the stored group information. Such information may then be used by the photo uploaded component to determine whether a photo is applicable. This upload may happen from any device (e.g. the user's PC) which understands the metadata embedded in the pictures. Note, storing group information as meta data is the preferred choice because in this way each image contains the appropriate information.

Note, in FIG. 3 typically reference numerals of the form 1xx designate subordinate components and those of the form 2xx designate master components. In the figure, specific devices are shown as having specific components depending upon whether they are an initiator, a master or a subordinate in the system. However this is for ease of explanation only. In the preferred embodiment each device comprises subordinate, master and initiator components. In this way any device may fulfil any of the roles. Of course, at any time, all devices will preferably be running subordinate componentry but only one device will be running master componentry.

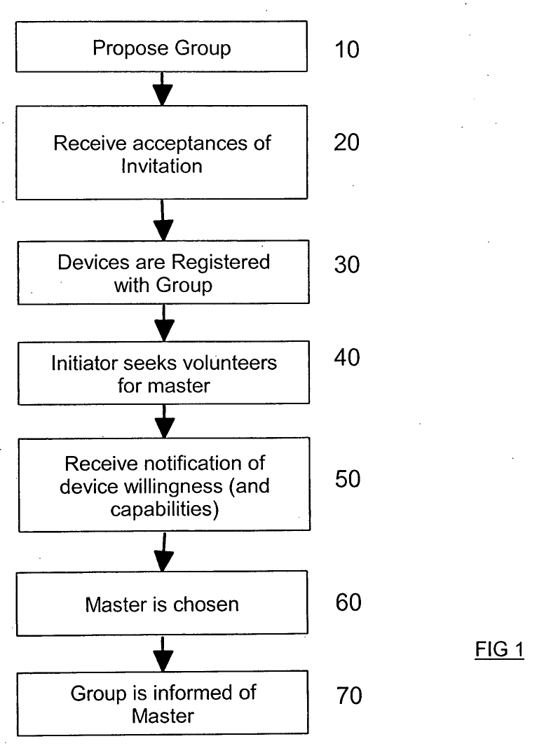

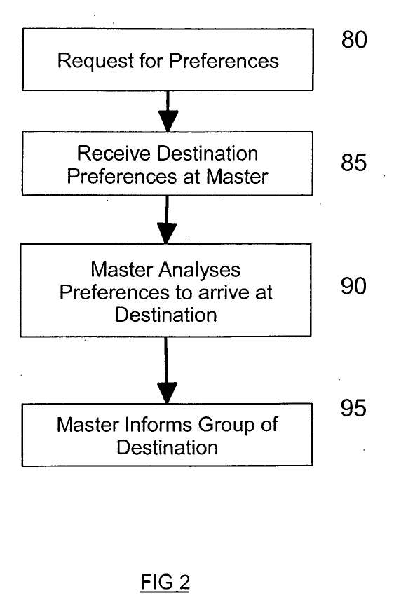

It should also be noted that steps 40 to 70 of FIG. 1 may occur again during the life of the group (e.g. if the master goes offline).

Finally, as indicated above a member may come late to a group (a newcomer). Since it is likely that by this time a destination will have been negotiated, a new joiner may simply ask another member for its appropriate group data. The new joiner can then be provided with that member's group information (i.e. the information that relates to the relevant group). The member being asked may authenticate the newcomer; for example, by asking for a passcode or determining whether the newcomer fulfils group criteria. Such information may have to be first requested from the master or indeed the newcomer may be directed to the master for group information.

Note also that a destination for a group may not be fixed. For example, renegotiation may take place from time to time. For example, a member of the group may request renegotiation of a group destination. The master of the group may then request that group members send out new preference information and analyse this to determine whether a new group destination is appropriate.

1. A method for a master of a group of devices to determine a destination at which to store data associated with the devices in the group, the method comprising the steps of:
receiving destination preference information from each device in the group of devices;
analysing the preference information received to arrive at a preferred destination; and
informing the devices in the group of the preferred destination to be used to store data.

2. The method of claim 1 comprising the further step of volunteering to be master of the group.

3. The method of claim 1 comprising the further step of requesting that each group member send its destination preference information.

4. The method of claim 1, wherein the step of analysing the preference information received comprises applying rules to the preference information, thereby weighting the importance of the preference information received from group members.

5. The method of claim 1 comprising the further steps of:
receiving a request for renegotiation of the preferred destination;
requesting new preference information from the group members;
analysing said new preference information; and
determining whether a new destination is appropriate.

6. A method for an initiator device to initiate the process of determining a destination at which to store data associated with a plurality of devices, the method comprising the steps of:
asking each of the plurality of devices whether it wishes to join a group, the purpose of the group being to arrive at a common destination for storing data associated with the plurality of devices; and
receiving acceptances to join the group from the plurality of devices.

7. The method of claim 6, wherein the step of asking each of the plurality of devices whether it wishes to join the group comprises providing the devices with information as to the purpose of the group.

8. The method of claim 6, wherein the step of receiving acceptances comprises:
authenticating any received acceptances; and
registering those devices which have been authenticated as group members.

9. The method of claim 6 comprising the further step of monitoring for new devices to invite to join the group.

10. The method of claim 6 comprising the further step of receiving a message from at least one device in the group volunteering to be master of the group.

11. The method of claim 10 comprising the further steps of:
analysing any messages received by which a device is volunteering to be master;
selecting a device as master of the group; and
informing the group which device has been selected as master of the group.

12. An apparatus for a master of a group of devices to determine a destination at which to store data associated with the devices in the group, the apparatus comprising:
means for receiving destination preference information from each device in the group of devices;
means for analysing the preference information received to arrive at a preferred destination; and
means for informing the devices in the group of the preferred destination to be used to store data.

13. The apparatus of claim 12 comprising means for volunteering to be master of the group.

14. The apparatus of claim 12 comprising means for requesting that each group member send its destination preference information.

15. The apparatus of claim 12, wherein the means for analysing the preference information received comprises means for applying rules to the preference information, thereby weighting the importance of the preference information received from group members.

16. The apparatus of claim 12 comprising:
means for receiving a request for renegotiation of the preferred destination;
means for requesting new preference information from the group members;
means for analysing said new preference information; and
means for determining whether a new destination is appropriate.

17. A computer program stored on a computer readable medium and associated with a master of a group of devices to determine a destination at which to store data associated with the devices in the group, the computer program comprising:
program means for receiving destination preference information from each device in the group of devices;
program means for analysing the preference information received to arrive at a preferred destination; and
program means for informing the devices in the group of the preferred destination to be used to store data.

18. The computer program according to claim 17, further comprising program means for requesting that each group member send its destination preference information.

19. The computer program according to claim 17, wherein the program means for analysing the preference information received comprises program means for applying rules to the preference information, thereby weighting the importance of the preference information received from group members.

20. The computer program according to claim 17, further comprising:
program means for receiving a request for renegotiation of the preferred destination;
program means for requesting new preference information from the group members;
program means for analysing said new preference information; and
program means for determining whether a new destination is appropriate.
